(19) United States
(12) Patent Application Publication
(10) Pub. No.: US 2023/0045987 A1
(43) Pub. Date: Feb. 16, 2023

(54) TRIGGER SWITCH AND ELECTRIC DEVICE

(71) Applicant: OMRON Corporation, Kyoto-shi, KYOTO (JP)

(72) Inventors: Takumi FUJIHARA, Kyoto-shi (JP); Taiki KOYAMA, Kyoto-shi (JP); Kazushi MAETA, Kyoto-shi (JP)

(73) Assignee: OMRON Corporation, Kyoto-shi, KYOTO (JP)

(21) Appl. No.: 17/791,924

(22) PCT Filed: Jan. 28, 2021
(86) PCT No.: PCT/JP2021/002945

§ 371 Date: Jul. 11, 2022

(30) Foreign Application Priority Data
Feb. 27, 2020 (JP) 2020-031712

(51) Int. Cl. H01H 13/14; H01H 13/20; H01H 13/04

(52) U.S. Cl. CPC H01H 13/14; H01H 13/20; H01H 13/04

(57) ABSTRACT

A trigger switch includes a trigger, a casing, a compression spring, and a sealing member. The trigger includes a trigger body to which a force is applied when an operator performs a pushing operation, and a trigger shaft extending from the trigger body toward a pushing direction. The casing holds the trigger so as to guide the trigger shaft along the pushing direction when the pushing operation of the trigger is performed. The compression spring is fitted to the outside of the trigger shaft between the trigger and the casing. The sealing member is disposed between the trigger and the casing so as to be fitted to a further outside of the compression spring and cover the trigger shaft and the compression spring.

### TECHNICAL FIELD

The present invention relates to a trigger switch that drives a drive unit by pushing a trigger, and an electric device using the trigger switch.

### BACKGROUND ART

In an electric device (e.g., an electric tool such as an electric driver), a trigger switch is used generally. The trigger switch used in the electric device turns on the power to a motor (drive unit) by a user's pushing operation of a trigger to drive the electric device, and turns off the power to the motor by releasing the pushing operation of the trigger to stop the electric device.

Patent Document 1 discloses a trigger switch including a trigger, a casing, and an elastic member. The trigger switch in Patent Document 1 has a configuration in which a trigger is slidably disposed between an off-position and an on-position with respect to a casing, and an elastic member is disposed between the trigger and the casing. The trigger not receiving the pushing operation is held at the off-position by the biasing force of the elastic member. By pushing the trigger against the biasing force of the elastic member, the trigger can be moved to the on-position.

### PRIOR ART DOCUMENT

### PATENT DOCUMENT

Patent Document 1: Japanese Unexamined Patent Publication No. 2018-170190

### SUMMARY OF THE INVENTION

### Problems to be Solved by the Invention

An electric device (in particular, an electric tool) may be used in a place with a lot of dust or moisture, but Patent Document 1 does not particularly disclose dust-resistant and water-resistant measures for the trigger switch.

When dust enters the sliding portion of the trigger, the sliding of the trigger may not be smoothly performed, or when moisture enters the trigger switch, rust may be generated in an internal metal member. Therefore, when dust-resistant and water-resistant measures are not taken in the trigger switch, it is necessary to take measures such as seal protection on the electric device side incorporating the trigger switch. When the trigger switch has dust-resistant and water-resistant functions, excessive seal protection is not required on the electric device side, and the degree of freedom in design in the electric device can be increased.

The present invention has been made in view of the above problems, and an object of the present invention is to provide a trigger switch and an electric device excellent in dust-resistant and water-resistant performance.

### Means for Solving the Problem

In order to solve the above problem, a trigger switch according to a first aspect of the present invention is a trigger switch incorporated and used in an electric device, the trigger switch including: a trigger configured to drive a drive unit of the electric device by a pushing operation from an operator; a casing configured to hold the trigger in a pushable manner; a compression spring configured to bias the trigger in a direction opposite to a pushing direction; and a sealing member configured to seal a gap between the trigger and the casing. The trigger includes a trigger body to which a force is applied when the operator performs the pushing operation, and a trigger shaft extending from the trigger body toward the pushing direction. The casing holds the trigger so as to guide the trigger shaft along the pushing direction when the pushing operation of the trigger is performed. The compression spring is fitted to the outside of the trigger shaft between the trigger and the casing. The sealing member is fitted to a further outside of the compression spring between the trigger and the casing, covers the trigger shaft and the compression spring, and is disposed such that the sealing member is fixed by a reaction force of the compression spring.

With the above configuration, the sealing member covers the trigger shaft between the trigger and the casing, whereby dust can be prevented from entering the sliding portion of the trigger shaft. The sealing member can not only waterproof the compression spring but also prevent moisture from entering the inside of the trigger switch (the inside of the casing) through a gap around the trigger shaft. It is thereby possible to provide a trigger switch having excellent dust-resistant and water-resistant performance.

In the trigger switch, an opening into which the trigger shaft is inserted and a flange portion formed around the opening are formed on the front end surface of the sealing member, and the sealing member is disposed such that the flange portion is sandwiched between a rear surface of the trigger body and the front end of the compression spring.

With the above configuration, by applying the biasing force of the compression spring to the flange portion of the sealing member, the front end surface of the sealing member is pressed against the rear surface of the trigger body, and a sufficient sealing effect can be obtained. The biasing force of the compression spring acts to hold the sealing member at the normal position, so that it is also possible to omit an inspection step for inspecting whether or not the sealing member is fitted to a normal position with respect to the trigger shaft.

In order to solve the above problem, an electric device according to a second aspect of the present invention includes the trigger switch described above.

### Effect of the Invention

The trigger switch and the electric device of the present invention have an effect that the trigger switch can have excellent dust-resistant and water-resistant functions by providing the sealing member covering the trigger shaft and the compression spring.

### BRIEF DESCRIPTION OF THE DRAWINGS

FIG. 1 is a view illustrating an appearance of a trigger switch according to an embodiment of the present invention and is a perspective view of the trigger switch as viewed from diagonally above the front.

FIG. 2 is an exploded perspective view of the trigger switch.

FIG. 3 is a longitudinal sectional view of the trigger switch.

FIG. 4 is an exploded perspective view illustrating an assembly of a casing and a forward and reverse switching lever illustrated in FIG. 2 in a further exploded manner.

FIGS. 5(a) to 5(d) are perspective views illustrating a procedure for attaching the forward and reverse switching lever to an upper casing.

FIG. 6 is a perspective view illustrating a schematic configuration of a main casing in an electric tool to which the trigger switch is applied.

### MODE FOR CARRYING OUT THE INVENTION

An embodiment of the present invention will be described below with reference to the drawings.

### Application Example

A trigger switch described in the present application is applied to various electric devices including electric tools such as an electric driver, an electric wrench, and an electric grinder. In the embodiment illustrated below, such a trigger switch will be described with reference to the drawings.

### Embodiment

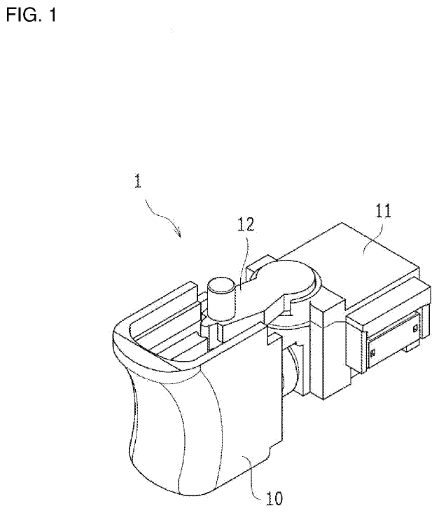

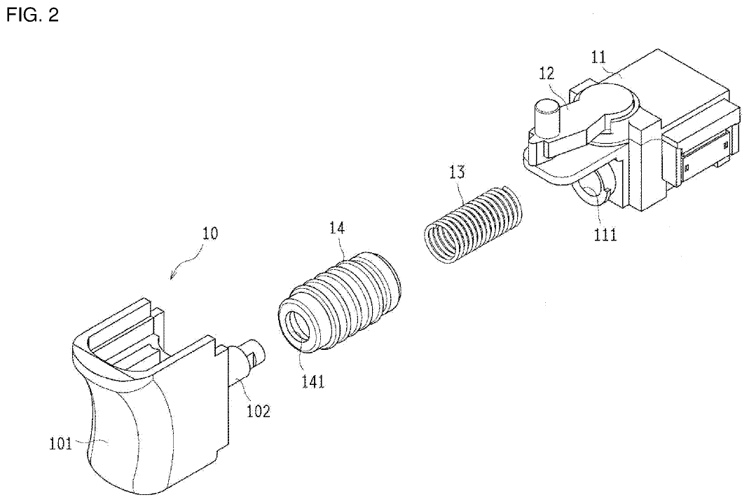

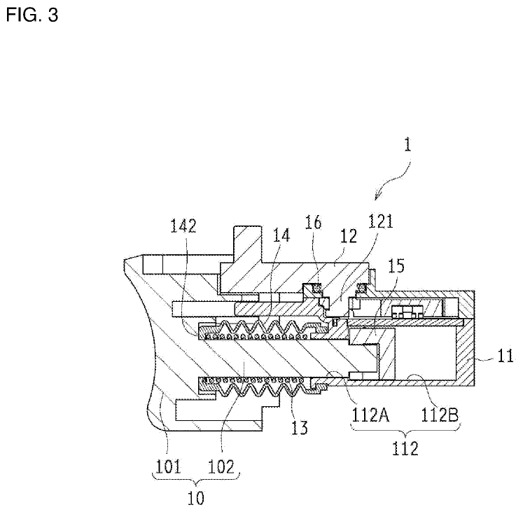

FIG. 1 is a view illustrating an appearance of a trigger switch 1 according to the embodiment and is a perspective view of the trigger switch 1 as viewed from diagonally above the front. FIG. 2 is an exploded perspective view of the trigger switch 1. FIG. 3 is a longitudinal sectional view of the trigger switch 1. The trigger switch 1 is a switch operated by an operator of an electric device, and when the operator performs a pushing operation to push the trigger 10 of the trigger switch 1, a drive unit (not illustrated) such as an electric motor built in the electric device is driven.

As illustrated in FIG. 1, the trigger switch 1 is incorporated in the electric device, and includes a casing 11 that holds the trigger 10 in a pushable manner, and a trigger 10 that can be pushed by the operator. In addition, the trigger switch 1 includes a forward and reverse switching lever 12 that performs forward and reverse switching of the driving direction of the drive unit, for example, the rotation direction of the electric driver. In the following description, for the directions of the trigger switch 1, the side where the trigger 10 is mounted is expressed as front, the casing 11 side as rear, the forward and reverse switching lever 12 side as upper, and the opposite side to the forward and reverse switching lever 12 as lower. However, these are directions for convenience of description and do not limit the directions when the trigger switch 1 is used.

As illustrated in FIGS. 2 and 3, the trigger 10 includes a trigger body 101 to which a force is applied when the operator performs a pushing operation, and a trigger shaft 102 extending rearward of the trigger body 101 (i.e., toward the pushing direction). The casing 11 has a shaft insertion port 111 opened on the front surface side and a shaft housing chamber 112 formed behind the shaft insertion port 111. The shaft insertion port 111 is an opening for the insertion of the trigger shaft 102 into the casing 11. The shaft housing chamber 112 is a space that becomes a movement space of the trigger shaft 102 at the time of the pushing operation of the trigger 10. Although not described in detail, a switch or the like is disposed in the shaft housing chamber 112, the switch or the like being configured to drive the drive unit of the electric device when the pushing operation of the trigger 10 is performed.

In the shaft housing chamber 112, the front side is a shaft guide 112A, and the rear side is a stopper guide 112B. The shaft guide 112A has an inner diameter substantially equal to the outer diameter of the trigger shaft 102 (there may be a slight gap) and guides the movement (sliding) of the trigger 10 along the axial direction. A stopper member 15 is attached to the rear end of the trigger shaft 102, and the stopper member 15 is allowed only to move in the stopper guide 112B. This prevents the trigger 10 from falling off the casing 11.

Between the trigger 10 and the casing 11, a compression spring 13 is fitted to the outside of the trigger shaft 102, and a sealing member 14 is fitted to the further outside of the compression spring 13. Accordingly, the sealing member 14 is disposed so as to cover the trigger shaft 102 and the compression spring 13. The compression spring 13 is disposed between the rear surface of the trigger body 101 and the front surface of the casing 11 and applies a forward biasing force to the trigger 10 (i.e., the opposite side to the pushing direction). When the operator performs the pushing operation of the trigger 10, the trigger 10 moves rearward against the biasing force of the compression spring 13. When the operator releases the pushing operation of the trigger 10, the trigger 10 moves forward by the biasing force of the compression spring 13 and returns to the initial position.

The sealing member 14 is a substantially cylindrical member disposed so as to cover the outer peripheries of the trigger shaft 102 and the compression spring 13. An opening 141 having substantially the same diameter as the outer diameter of the trigger shaft 102 is provided on the front end surface of the sealing member 14, and the trigger shaft 102 is inserted into the opening 141. The opening 141 is surrounded by a flange portion 142, and the flange portion 142 is disposed so as to be sandwiched between the rear surface of the trigger body 101 and the front end of the compression spring 13. In other words, the compression spring 13 applies a biasing force to the trigger 10 via the flange portion 142 of the sealing member 14, and the reaction force of the compression spring 13 is also used for fixing the sealing member 14. The rear end of the sealing member 14 is attached to the front surface of the casing 11 so as to completely cover the periphery of the shaft insertion port 111. Furthermore, the body portion of the sealing member 14 is formed in a bellows shape so as to easily expand and contract in the axial direction with the movement of the trigger 10.

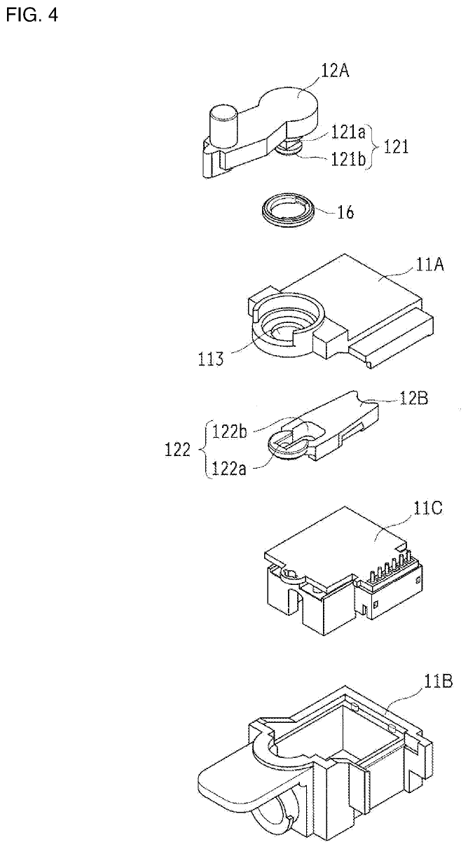

The assembly of the trigger switch 1 can be performed by, for example, the following procedure. First, the sealing member 14 is fitted into the trigger shaft 102 of the trigger 10, and the compression spring 13 is inserted between the trigger shaft 102 and the sealing member 14. Next, the trigger shaft 102 into which the compression spring 13 and the sealing member 14 are fitted is inserted into the casing 11 from the shaft insertion port 111, and the stopper member 15 is attached to the rear end of the trigger shaft 102. In FIG. 2, the casing 11 is described as one integrated member, but in practice, the casing 11 is configured by assembling a plurality of parts. The stopper member 15 can be attached to the trigger shaft 102 in a state where the trigger shaft 102 has been inserted in a part (a lower casing 11B illustrated in FIG. 4) of the casing 11 before assembly. Finally, the assembly of the casing 11 is completed to complete the trigger switch 1.

The trigger switch 1 having the above configuration is made excellent in dust-resistant and water-resistant performance by the sealing member 14. That is, by the sealing member 14 covering the trigger shaft 102 between the trigger 10 and the casing 11, it is possible to prevent dust from entering the sliding portion of the trigger shaft 102 (the sliding surface between the trigger shaft 102 and the shaft guide 112A). In addition, the sealing member 14 can not only waterproof the compression spring 13 but also prevent moisture from entering the trigger switch 1 through a gap between the trigger shaft 102 and the shaft guide 112A. As described above, by providing the trigger switch 1 with dust-resistant and water-resistant functions, excessive seal protection is not required on the electric device side in which the trigger switch 1 is incorporated, and the degree of freedom in design in the electric device can be increased.

In the trigger switch 1, the compression spring 13 is fitted to the outside of the trigger shaft 102, whereby the trigger switch 1 can be reduced in size. The compression spring 13 that applies the biasing force to the trigger 10 can be disposed inside the casing 11 (e.g., behind the trigger shaft 102). However, with such a configuration, a space for disposing the compression spring 13 is required in the axial direction of the trigger shaft 102, and the reduction in the size of the trigger switch 1 is hindered. By fitting the compression spring 13 to the outside of the trigger shaft 102, the space for disposing the compression spring 13 in the casing 11 can be omitted, which contributes to the reduction in the size of the trigger switch 1.

In order to further improve the dust-resistant and water-resistant performance by the sealing member 14, it is necessary to press at least a part of the sealing member 14 against the trigger 10 to obtain a sufficient sealing effect. In the trigger switch 1, by applying the biasing force of the compression spring 13 to the flange portion 142 of the sealing member 14, the front end surface of the sealing member 14 can be pressed against the rear surface of the trigger body 101, and a sufficient sealing effect can be obtained. Normally, an inspection step is required for inspecting whether or not the sealing member 14 is fitted to a normal position with respect to the trigger shaft 102 (a position where the front end surface of the sealing member 14 is in contact with the rear surface of the trigger body 101). In contrast, in the trigger switch 1 having the above configuration, the biasing force of the compression spring 13 acts to hold the sealing member 14 at the normal position, so that the above inspection step can be omitted.

Next, the structure of the casing 11 including the forward and reverse switching lever 12 will be described in more detail. As illustrated in FIG. 3, the forward and reverse switching lever 12 has a rotating shaft 121 rotatably supported with respect to the casing 11, and an O-ring 16 is fitted around the rotating shaft 121. That is, the O-ring 16 is provided to obtain dust-resistant and water-resistant functions between the rotating shaft 121 of the forward and reverse switching lever 12 and the casing 11.

In order to obtain sufficient dust-resistant and water-resistant functions by the O-ring 16, it is necessary to apply a sufficient pressure contact force in at least one direction to the entire circumference of the O-ring 16 (i.e., the entire circumference around the rotating shaft 121). The trigger switch 1 according to the embodiment is configured to be able to apply a sufficient pressure contact force to the entire circumference of the O-ring 16 in the axial direction of the rotating shaft 121. In addition, the trigger switch 1 is configured to be able to improve the ease of assembly at the time of attaching the forward and reverse switching lever 12 to the casing 11.

FIG. 4 is an exploded perspective view illustrating the assembly of the casing 11 and the forward and reverse switching lever 12 illustrated in FIG. 2 in a further exploded manner. As illustrated in FIG. 4, the casing 11 can be further disassembled into an upper casing 11A, a lower casing 11B, and a circuit board portion 11C. The forward and reverse switching lever 12 can be further disassembled into an upper lever member 12A and a lower lever member 12B.

The upper lever member 12A has the above-described rotating shaft 121, and a shaft hole portion 113 for rotatably and axially supporting the rotating shaft 121 is formed in the upper casing 11A. The rotating shaft 121 has an engagement shaft portion 121a having a rectangular cross section at a part of the shaft, and a lower portion of the engagement shaft portion 121a (the tip of the rotating shaft 121) is a guard portion 121b having a diameter larger than that of the engagement shaft portion 121a. The lower lever member 12B has an attachment hole 122 for attachment to the rotating shaft 121. In the attachment hole 122, an engagement hole portion 122a is formed on the front side, and an insertion hole portion 122b is formed on the rear side so as to be continuous with the engagement hole portion 122a. The engagement hole portion 122a has the same width as the engagement shaft portion 121a in the direction orthogonal to the front-rear direction. The insertion hole portion 122b is a hole having a size into which the guard portion 121b can be inserted.

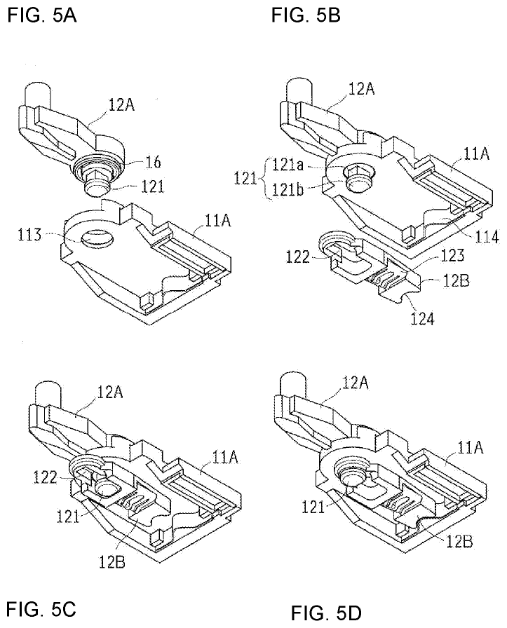

A brush 123 (cf. FIG. 5(b)) serving as a contact of the circuit board portion 11C is attached to the lower surface of the lower lever member 12B. A leaf spring 114 (cf. FIG. 5(b)) is attached to the rear of the lower surface of the upper casing 11A, and a recess 124 (cf. FIG. 5(b)) is formed at the rear end of the lower lever member 12B. The leaf spring 114 and the recess 124 are provided to hold the forward and reverse switching lever 12 at the reference position and provide a click feeling when the forward and reverse switching lever 12 is switched.

The forward and reverse switching lever 12 is attached to the upper casing 11A such that the rotating shaft 121 penetrates the shaft hole portion 113, and the attachment procedure thereof will be described below with reference to FIGS. 5(a) to 5(d).

First, the O-ring 16 is attached to the rotating shaft 121 of the upper lever member 12A, and then, the upper lever member 12A is attached to the upper casing 11A from above such that the rotating shaft 121 penetrates the shaft hole portion 113 (FIGS. 5(a) to 5(b)).

Subsequently, the lower lever member 12B is attached to the rotating shaft 121 of the upper lever member 12A from below with respect to the upper casing 11A (FIGS. 5(b) to 5(c)). At this time, the rotating shaft 121 is inserted into the attachment hole 122 of the lower lever member 12B from the insertion hole portion 122b.

Finally, the lower lever member 12B is slid rearward with respect to the rotating shaft 121, and the engagement hole portion 122a of the attachment hole 122 is engaged with the engagement shaft portion 121a of the rotating shaft 121 (FIGS. 5(c) to 5(d)). As a result, the lower lever member 12B is attached to the upper lever member 12A in a non-rotatable manner, and the lower lever member 12B is fixed to the upper lever member 12A. When the attachment of the upper lever member 12A to the upper casing 11A is completed, the casing 11 can be assembled by combining the upper casing 11A, the lower casing 11B, and the circuit board portion 11C. Specifically, the circuit board portion 11C is assembled to the lower casing 11B to which the trigger 10 is attached, and the upper casing 11A to which the forward and reverse switching lever 12 is attached is further assembled on the circuit board portion 11C.

As described above, the dust-resistant and water-resistant functions around the rotating shaft 121 of the forward and reverse switching lever 12 are obtained by the O-ring 16. The O-ring 16 is disposed such that the entire circumference thereof is sandwiched between the upper lever member 12A and the upper casing 11A. Under the upper casing 11A, the lower lever member 12B is attached to the rotating shaft 121, and the lower lever member 12B has a function of preventing an increase in the distance between the upper lever member 12A and the upper casing 11A (defining the distance between the upper lever member 12A and the upper casing 11A). In other words, by providing the engagement shaft portion 121a in the rotating shaft 121 at an appropriate position and fixing the lower lever member 12B at a predetermined position of the rotating shaft 121, the lower lever member 12B can have an action of pushing the upper casing 11A toward the upper lever member 12A. Accordingly, a sufficient pressure contact force in the axial direction can be applied to the entire circumference of the O-ring 16 (i.e., the entire circumference around the rotating shaft 121). As a result, the O-ring 16 can exhibit a sufficient sealing effect, and the trigger switch 1 can be provided with excellent dust-resistant and water-resistant functions.

Further, the pressure contact force for enhancing the sealing effect of the O-ring 16 is obtained by engaging the engagement hole portion 122a of the lower lever member 12B with the engagement shaft portion 121a of the rotating shaft 121. That is, the pressure contact force in the O-ring 16 is generated by the sliding movement of the lower lever member 12B in the assembly stage from FIG. 5(c) to FIG. 5(d), and no pressure contact force has been generated in the O-ring 16 in the previous stage. This also simplifies the assembly procedure for applying the pressure contact force in the O-ring 16.

Furthermore, in the assembly procedure described above, the forward and reverse switching lever 12 is attached to the upper casing 11A, and after the attachment of the forward and reverse switching lever 12 to the upper casing 11A, the forward and reverse switching lever 12 is not easily detached from the upper casing 11A. Thus, the forward and reverse switching lever 12 is not detached at the stage of assembling the casing 11 (upper casing 11A, lower casing 11B, and circuit board portion 11C), and it is possible to improve the ease of assembly of the trigger switch 1.

When an assembly failure occurs at the stage of attaching the forward and reverse switching lever 12 of the upper casing 11A, the upper casing 11A and the forward and reverse switching lever 12 are to be discarded due to the assembly failure, and the lower casing 11B and the circuit board portion 11C are not to be discarded. Hence the range of disposal due to the assembly failure can be reduced, leading to a reduction in disposal loss.

Further, in the trigger switch 1 having the above configuration, the forward and reverse switching lever 12 is divided into the two members of the upper lever member 12A and the lower lever member 12B, and the upper casing 11A is sandwiched between the upper lever member 12A and the lower lever member 12B. With this configuration, the shaft hole portion 113 into which the rotating shaft 121 of the forward and reverse switching lever 12 is inserted can be formed only in one member, that is, the upper casing 11A. As a result, no gap is generated in the casing around the rotating shaft, and this can also enhance the dust-resistant and water-resistant performance of the trigger switch. Naturally, when no gap is generated in the casing around the rotating shaft, there is also no need for a step of closing the gap by ultrasonic welding, laser welding, or the like.

Further, when the forward and reverse switching lever 12 is divided into two members of the upper lever member 12A and the lower lever member 12B, these two members can be formed of different materials. For example, since the lower lever member 12B functions as a connection circuit (charger) with the circuit board portion 11C inside the casing 11, the safety of the trigger switch 1 can be enhanced by using a flame retardant material for the material of the lower lever member 12B. On the other hand, for example, a transmissive material through which laser light is transmitted can be used for the material of the upper lever member 12A. By using the transmissive material for the upper lever member 12A, after the assembly of the trigger switch 1, laser welding to the casing 11 can be performed by laser light transmitted through the upper lever member 12A. That is, with the casing 11 having been divided into the upper casing 11A and the lower casing 11B, a gap between the coupled portions of these casings is preferably closed by laser welding or the like after assembly.

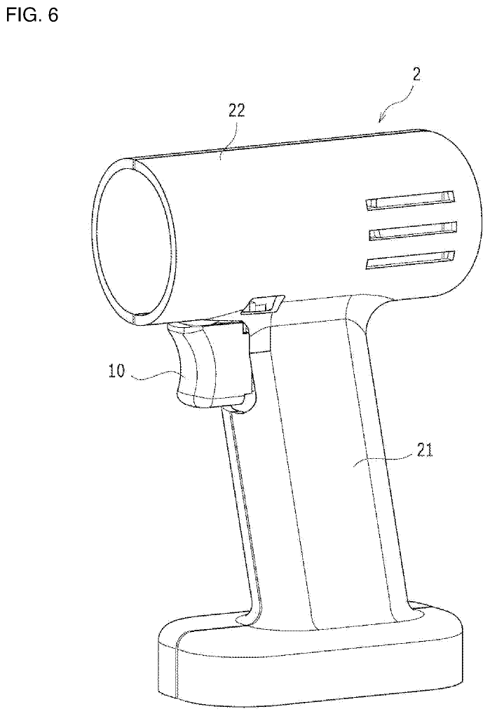

FIG. 6 is a perspective view illustrating a schematic configuration of a main casing 2 in the electric tool (electric device) to which the trigger switch 1 according to the first embodiment is applied. The main casing 2 of the electric tool includes a handle 21, which is gripped by the operator at the time of use, and a body holder 22 to which a functional body portion of the electric tool (not illustrated, a body of an electric driver or an electric wrench) is attached. The trigger switch 1 is incorporated in the handle 21, and the trigger 10 is exposed at a position where the operator gripping the handle 21 can easily operate. The functional body portion of the electric tool is electrically connected to the trigger switch 1 inside the main casing 2.

The embodiment disclosed herein is illustrative in all respects and does not provide a basis for a limited interpretation. Therefore, the technical scope of the present invention is not to be construed only by the above-described embodiment but is defined based on the description of the claims. In addition, meanings equivalent to the claims and all modifications within the scope are included.

The present international application claims priority based on Japanese Patent Application No. 2020-031712 filed with the Japan Patent Office on Feb. 27, 2020, and the entire contents of Japanese Patent Application No. 2020-031712 are incorporated herein by reference.

### DESCRIPTION OF SYMBOLS

1 trigger switch

10 trigger

101 trigger body

102 trigger shaft

11 casing

11A upper casing

11B lower casing

11C circuit board portion

111 shaft insertion port

112 shaft housing chamber

112A shaft guide

112B stopper guide

113 shaft hole portion

114 leaf spring

12 forward and reverse switching lever

12A upper lever member

12B lower lever member

121 rotating shaft

121a engaging shaft portion

121b guard portion

122 attachment hole

122a engagement hole portion

122b insertion hole portion

123 brush

124 recess

13 compression spring

14 sealing member

141 opening

142 flange portion

15 stopper member

16 O-ring

2 main casing

21 handle

22 body holder

1. A trigger switch incorporated and used in an electric device, the trigger switch comprising:
a trigger configured to drive a drive unit of the electric device by a pushing operation from an operator;
a casing configured to hold the trigger in a pushable manner;
a compression spring configured to bias the trigger in a direction opposite to a pushing direction; and
a sealing member configured to seal a gap between the trigger and the casing,
wherein the trigger comprises a trigger body to which a force is applied when the operator performs the pushing operation, and a trigger shaft extending from the trigger body toward the pushing direction,
the casing holds the trigger so as to guide the trigger shaft along the pushing direction when the pushing operation of the trigger is performed,
the compression spring is fitted to an outside of the trigger shaft between the trigger and the casing, and
the sealing member is fitted to a further outside of the compression spring between the trigger and the casing, covers the trigger shaft and the compression spring, and is disposed such that the sealing member is fixed by a reaction force of the compression spring.

2. The trigger switch according to claim 1, wherein
an opening into which the trigger shaft is inserted and a flange portion formed around the opening are formed on a front end surface of the sealing member, and
the sealing member is disposed such that the flange portion is sandwiched between a rear surface of the trigger body and a front end of the compression spring.

3. An electric device comprising the trigger switch according to claim 1.

4. An electric device comprising the trigger switch according to claim 2.
